(19) United States
(12) Patent Application Publication
(10) Pub. No.: US 2006/0248092 A1
(43) Pub. Date: Nov. 2, 2006

(54) Dynamic exception reporting service for heterogeneous structured enterprise data

(75) Inventors: Neal M. Keller, Hawthorne, NY (US); Kristoffer H. Rose, Poughkeepsie, NY (US); Michael Sava, Peekskill, NY (US); Murali Vridhachalam, Wappingers Falls, NY (US)

Correspondence Address: SCULLY SCOTT MURPHY & PRESSER, PC, 400 GARDEN CITY PLAZA, SUITE 300, GARDEN CITY, NY, 11530, US

(73) Assignee: INTERNATIONAL BUSINESS MACHINES CORPORATION, ARMONK, NY (US)

(21) Appl. No.: 11/118,137

(22) Filed: Apr. 29, 2005

(51) Int. Cl. G06F 7/00

(52) U.S. Cl. 707/100

(57) ABSTRACT

A computer-implemented technique that allows a per element mixture of “concrete” XML elements and “virtual” XML elements that are generated dynamically from external data sources. The technique extends the XML Schema language with declarations of how additional substructure is injected into existing instances. The instances created according to an XML schema with such extra declarations—called pseudo-elements and pseudo-attributes—thus mix original XML structure with the injected structure, but without creating a complete XML instance. The consumer of the structure cannot distinguish between the original and injected parts except by reading the XML Schema containing the declarations.

### BACKGROUND OF THE INVENTION

1. Field of Invention

The present invention relates most generally to the field of business intelligence and to providing an on-demand, dynamic exception reporting service to end users as well as providing a programmatic interface to applications. More specifically, the invention relates to providing decision support exception reporting capabilities on heterogeneous structured enterprise data sources, including but not limited to relational and Extensible Markup Language (XML) sources, by employing structured descriptions, including but not limited to schema describing XML instances, which include original and computed data fragments so that the searchable data is enhanced with additional metadata dynamically without the need to materialize complete data structure instances beforehand. The invention also relates to a system and technique for suggesting new computed data fragments to domain experts responsible for enhancing the available searchable metadata.

2. Description of Related Art

The growth of structured heterogeneous enterprise data, including relational and XML data, has increased the complexity of providing robust yet easy to use end user business intelligence tools, including exception reporting capabilities. An exception can refer to a condition, often an error, which causes a program or microprocessor to branch to a different routine. Moreover, an exception may be defined in business terms to encompass, e.g., lack of compliance with agreed upon performance goals. In order to provide a meaningful depth and breadth of reporting on enterprise wide information, it is common for most tools to provide a multitude of pre-programmed or “canned” reports. In addition, special reporting tools are also employed which often require an in depth understanding of both the tool and the underlying data.

Previously disclosed methods describe how to store XML data natively in relational databases along with relational data. Related art describes how to use available XML schemas to capture information about the types, inheritances, equivalence classes and integrity constraints of such XML data so as to customize the inclusion of such XML data in relational databases in order to facilitate efficient querying based on relational database tools. Taking a different approach to querying, the Data Format Description Langue (DFDL) standards describe how to convert non-XML data into XML format to enable querying with XML access languages such as XPath.

Related Federated Data Management concepts allow structured querying tools to uniformly access differently structured data sources using a single structuring principle. Federated Data Management (FDM) is provided as part of the Federal Enterprise Architecture (FEA), which is a comprehensive, business-driven framework for changing the Federal government's business and IT paradigm from agency-centric to Line-of-Business (LOB)-centric. For example, the relational structured query language (SQL) can be used to access XML data by storing (“shredding”) a copy of the XML data into a relational data structure that can then be accessed using SQL, and the SQLX standard describes how relational data can be accessed using a hierarchical query language such as XPath. SQLX is an abbreviation for SQL/XML, which defines a standardized mechanism for using SQL and XML together.

Furthermore, various W3C standards and emerging standards address the development and evolution of XML schema that are used to describe and validate XML instances. XML schemas are either used to describe actual XML data or to describe XML data that is entirely generated from a different data source in ways described by schema annotations. However, schemas are enhanced by annotation rather than by the addition of new elements only where all data is virtual.

### BRIEF SUMMARY OF THE INVENTION

The present invention addresses the above and other issues by providing a computer-implemented technique that allows a per element mixture of “concrete” XML elements and “virtual” XML elements that are generated dynamically from external data sources. The technique extends the XML Schema language with declarations of how additional substructure is injected into existing instances. The instances created according to an XML schema with such extra declarations—called pseudo-elements and pseudo-attributes—thus mix original XML structure with the injected structure. The consumer of the structure cannot distinguish between the original and injected parts except by reading the XML Schema containing the declarations.

The standard way of extending the XML Schema language is by using so-called “annotations”, and this mechanism is also used by other emerging standards to describe data generation. For example, the Data Format Description Language (DFDL) specifies XML Schema annotations to declare how data should be obtained from formatted (non-XML) files. The end-result, however, is a “complete” XML instance that is constructed from scratch by the DFDL engine that in turn uses the annotations, contrary to the novel mix of original and generated XML structure disclosed herein.

In one aspect of the invention, a computer-implemented method for enriching data sources includes creating a tree based organizing structure for heterogeneous structured enterprise data sources having associated structured data, including unmaterialized, computed data fragments on demand in individual data elements in the organizing structure, and navigating to nodes in the organizing structure so as to provide localized, context sensitive enrichment of the data sources.

In a further aspect, a computer-implemented method as described above is provided in which the tree based organizing structure comprises a virtual schema.

Corresponding program storage devices may also be provided.

### BRIEF DESCRIPTION OF THE DRAWINGS

These and other features, benefits and advantages of the present invention will become apparent by reference to the following text and figures, with like reference numbers referring to like structures across the views, wherein:

FIG. 1 is a schematic showing an example architecture and conceptual flow of an example system, including major technology infrastructures and user interfaces for stakeholders.

FIG. 2 is a schematic showing an example architecture and conceptual flow of an example system, including the positioning of the inventive application programming interface (API), which can be exposed as web services, and the inventive major technology infrastructures and user interfaces for stakeholders.

FIG. 3 illustrates an example user interface in which sponsors specify and modify selected service parameters and monitor performance of the provided exception reporting services against service level agreements with the provider.

FIG. 4 illustrates an example user interface where providers specify and modify all service parameters and monitor performance of the provided exception reporting services against service level agreements with the sponsor.

FIG. 5 illustrates an example domain expert interface where the domain expert identifies the raw XML and relational data sources and real schema, if available, to enable the inventive system to physically access the data.

FIG. 6 provides sample relational tables of data elements available to the domain expert for selection and use with the inventive system.

FIG. 7 illustrates an example domain expert interface in which the domain expert uses real schemas to create elements to build a virtual schema for use by the inventive system for user reporting.

FIG. 8 illustrates an example domain expert interface showing a completed initial virtual schema.

FIGS. 9a-d provide an example initial virtual schema produced by the inventive system.

FIG. 10 illustrates an example end user reporting interface in which the end user adds columns from the list of available schema elements and attributes provided by the initial virtual schema produced by the inventive system.

FIG. 11 illustrates an example list of library functions available for use with both the end user interface for report creation and the domain expert interface for the process of creating elements for the virtual schema used by the inventive system.

FIG. 12 illustrates an example end user reporting interface in which the end user specifies constraints to the report and views the results.

FIG. 13 provides examples of data elements from sample relational database tables available to the domain expert for selection and use with the inventive system.

FIG. 14 illustrates an example domain expert interface in which the domain expert is creating a new pseudo-element based on the findings of optional correlation processes of the inventive system.

FIG. 15 illustrates an example domain expert interface showing the completed creation of a new pseudo-element.

FIGS. 16a and 16b provide an example pseudo-element as part of an updated virtual schema produced by the inventive system.

FIG. 17 illustrates an example end user reporting interface where the end user has added a pseudo-element to the report and views the results.

FIG. 18 illustrates an example domain expert interface showing the creation of a pseudo-element based on a parameterized computation for the “what if” capability provided by the inventive system.

FIG. 19 provides an example pseudo-element, created based on a parameterized computation, as part of an updated virtual schema produced by the inventive system.

FIG. 20 illustrates an example domain expert interface showing the real time running of a correlation between two data elements to determine the strength of their relationship for consideration in formulating a new pseudo-element.

FIG. 21 illustrates an example domain expert interface showing the results from an optional regularly scheduled batch element correlation process of the inventive system.

FIG. 22 illustrates an example domain expert interface showing access to the user log analysis.

FIG. 23 illustrates an example domain expert interface showing access to user feedback and ratings on a report level.

FIG. 24 illustrates an example end user reporting interface where the end user rates the overall report as well as the individual elements including pseudo-elements provided by the inventive system.

FIG. 25 illustrates an example domain expert interface showing access to user feedback and ratings on an individual element level.

### DETAILED DESCRIPTION OF THE INVENTION

As mentioned above, the present invention provides a method and system that allows a per element mixture of “concrete” XML elements and “virtual” XML elements that are generated dynamically from external data sources. While richer structures can be used than tree structures, such as the “multidimensional graph structures” of OLAP, the present invention exploits a key feature of the data structure to which it is applied: that every node has a unique context. For trees, this is the path from the root. This allows us to express enriching the data in a context-sensitive way to avoid clutter. OLAP, or Online Analytical Processing, is a category of software tools that provides analysis of data stored in a database. OLAP tools enable users to analyze different dimensions of multidimensional data, for example, by providing time series and trend analysis views. OLAP often is used in data mining.

While previously disclosed techniques address various aspects of the problem of providing adaptive, easy to use exception reporting capability to end users of structured heterogeneous enterprise data, as part of business intelligence offerings, the present invention provides an end-to-end system which builds on current and previously disclosed techniques which attempt to provide a single view of this structured heterogeneous data. The present invention, by contrast, maintains the relational and XML data separate, rather than combining them either in a relational database or into complete XML instances, while dynamically enriching the available searchable data by extending the available metadata, rather than enhancing just the indexing of these structured heterogeneous data.

The present invention is based on the view that a structured description, such as, but not limited to, an XML document, can mix data that is already stored as XML with data that is generated by extraction from other data, e.g., from a database, as well as computed, e.g., using an expression. Such a combination is referred to as a Virtual XML instance because it appears as a single XML document where the user, e.g., application or programmatic interface cannot in general determine, for any particular data fragment, whether it is “original” or “computed”.

The present invention denotes computed elements and attributes as pseudo-elements and pseudo-attributes, respectively. This generalizes the row/column formula idea of spreadsheets to tree structures such as XML data. Such a system based on a Virtual XML Schema describing such a virtual XML instance does not need to generate entire XML instances beforehand. The user is able to explore parent and sibling relationships in the data space and to create queries including both original and computed data fragments that do not need to be computed and stored beforehand. Such a system can therefore be updated dynamically, to enhance the data space, with new original and computed data fragments, because the Virtual XML instance would be generated dynamically when needed. The system can include a programmatic interface and can be designed using a service-oriented architecture so that components can be added on demand and be provided or used by various stakeholders, such as a sponsor, service provider, domain expert user, or end user. Additionally, the use of the virtual schema instead of complete virtual instances reduces the computer resources required to provide an exception reporting service according to a requested performance level. In particular, the reduction in the required computer resources is due to the fact that the data fragments are materialized on-demand, locally and dynamically, as the user navigates. Otherwise the pseudo-elements are unmaterialized.

High Level Overview of System, including Build vs. Run Time

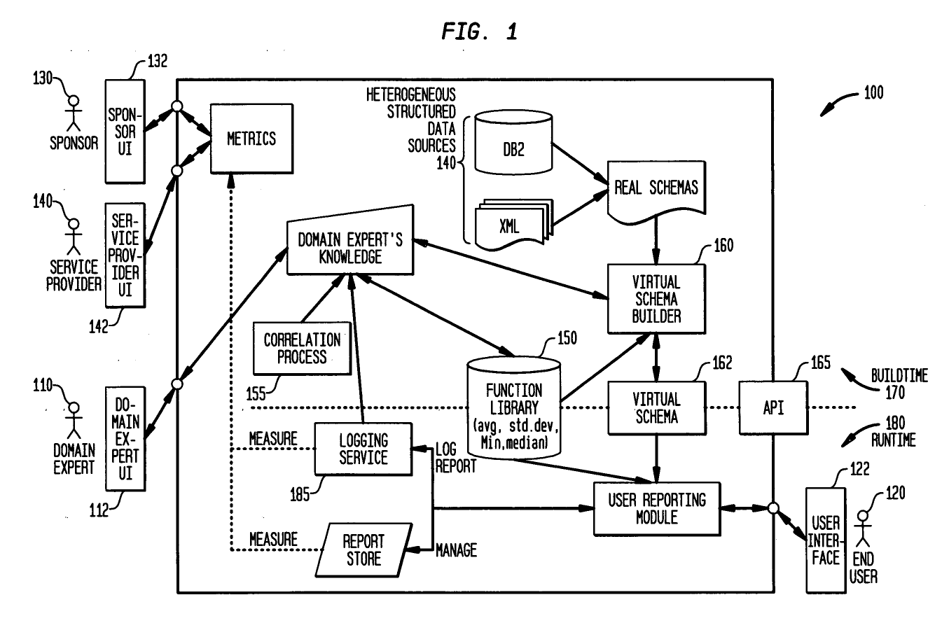

FIG. 1 is a schematic (block diagram) depicting an example architecture and conceptual flow of an example system 100 that applies service oriented architecture and technologies to provide on demand exception reporting services based on negotiated service level agreements between sponsors and service providers.

As shown in FIG. 1, there are four different types of users of the inventive system, in an example embodiment, each interacting with the application programming interface (API): (1) Domain Experts 110, (2) End Users 120 of the exception reporting system, (3) Sponsors, 130 and (4) Service Providers 140. The system provides a user interface for each type of user. The Domain Expert is responsible for setting up the structured heterogeneous data sources, creating the initial virtual schema, analyzing the user feedback and reports, analyzing the batch correlation results, and eventually enriching the data sources by updating the virtual schema with new relationships (e.g., pseudo-elements and attributes). The end users, presented with the available elements of the virtual schema, as created by the Domain Expert, can select elements and provide constraints and computations to elements to produce meaningful exception reports. The end users can help to enrich the data and provide useful data for the Service Provider metrics through the use of feedback and rating of the reports. Sponsors of the system specify the scope of the included data and other parameters of the required service. Service Providers specify and modify optional service provision parameters and monitor overall performance against the service level agreement with the Sponsor.

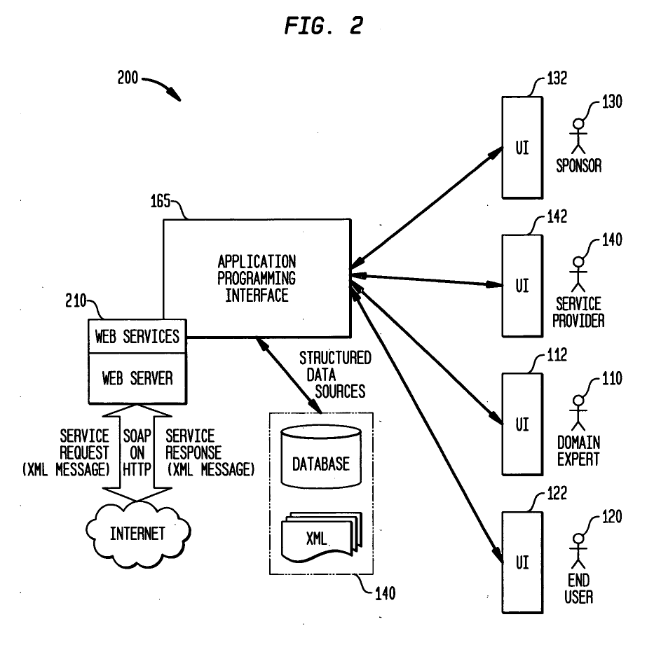

The inventive system includes a set of subsystem components, such as heterogeneous, structured data sources 140, function libraries 150, batch correlation processes 155, virtual schema builder 160, and API 165, all of which can be exposed as web services, and user interfaces 112, 122, 132 and 142, which interoperate to provide exception reporting services to the end user. For example, see the Web Services 210 in the example architecture and conceptual flow of an example system 200 (FIG. 2), which positions the API 165 between the Web Services 210 and all of the inventive major technology infrastructures and the user interfaces for the stakeholders.

The exception reporting services provided by the inventive system are consistent with the service level agreements (SLAs) between the Sponsor and the Service Provider, and are based on an agreed upon scope of included data, as well as performance criteria including metrics such as the average user satisfaction with the exception reporting process, the average end user cycle time to generate a report, and the average end user satisfaction with Domain Expert provided pseudo-elements.

As shown in FIG. 1, specific subsystem components are associated with either a build-time system 170 or a run-time system 180, with the exception of the function library 150 and virtual schema 162, which interact with both the build-time system and run-time system.

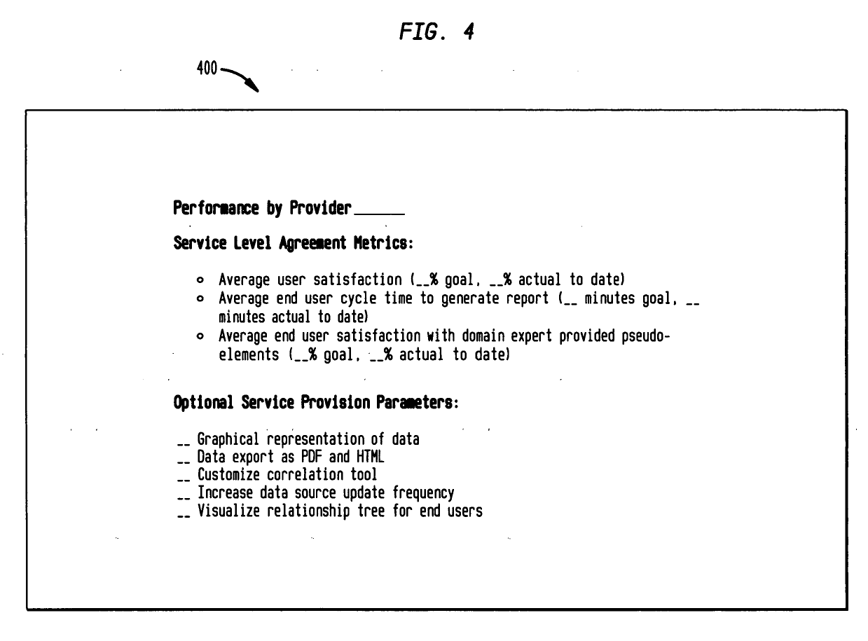

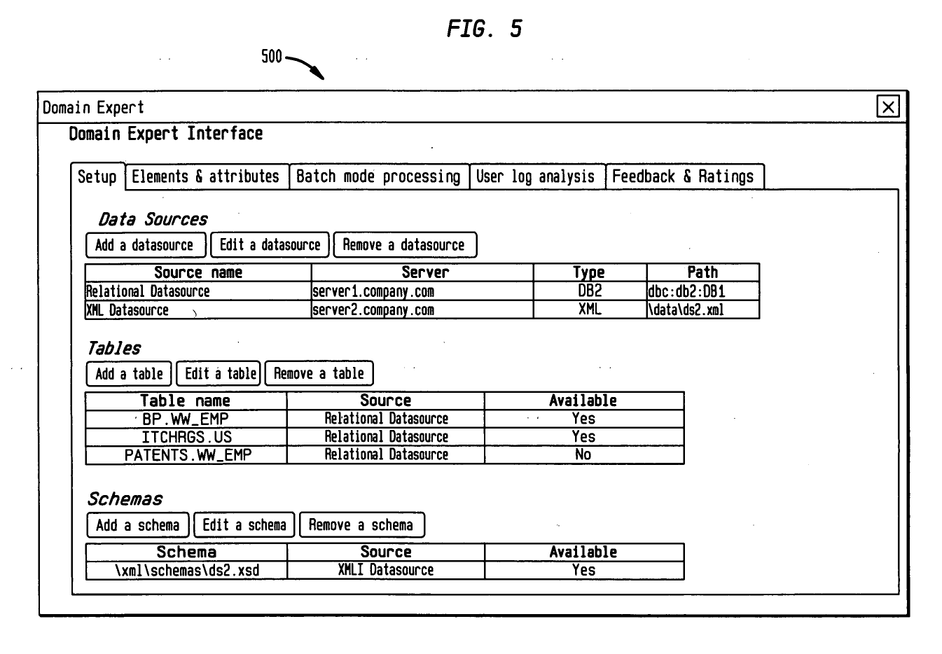

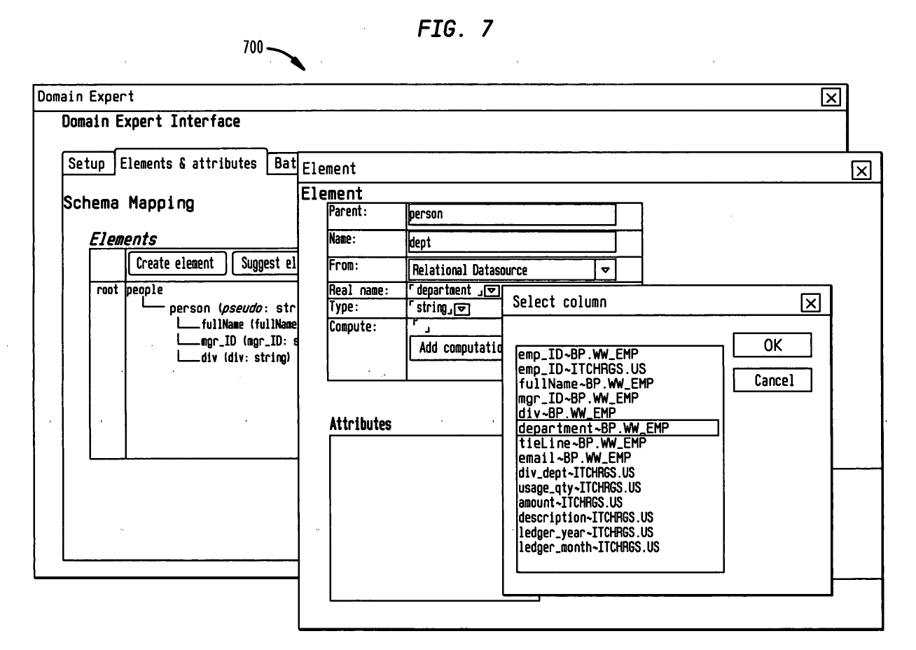

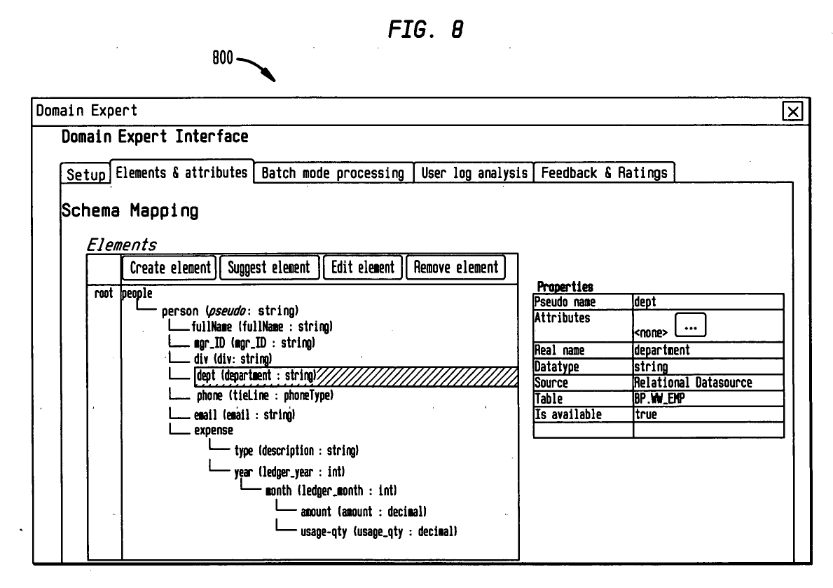

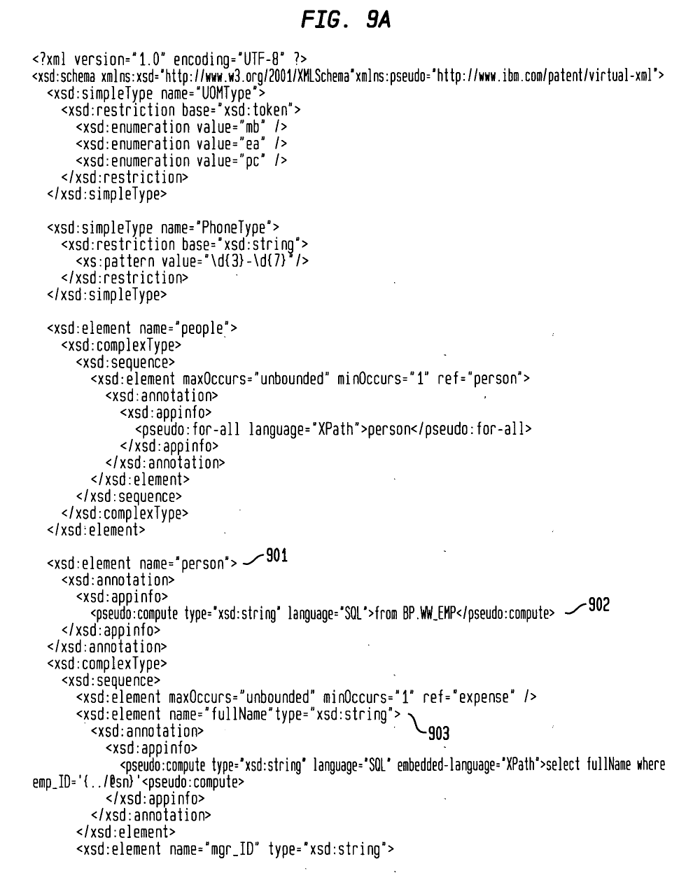

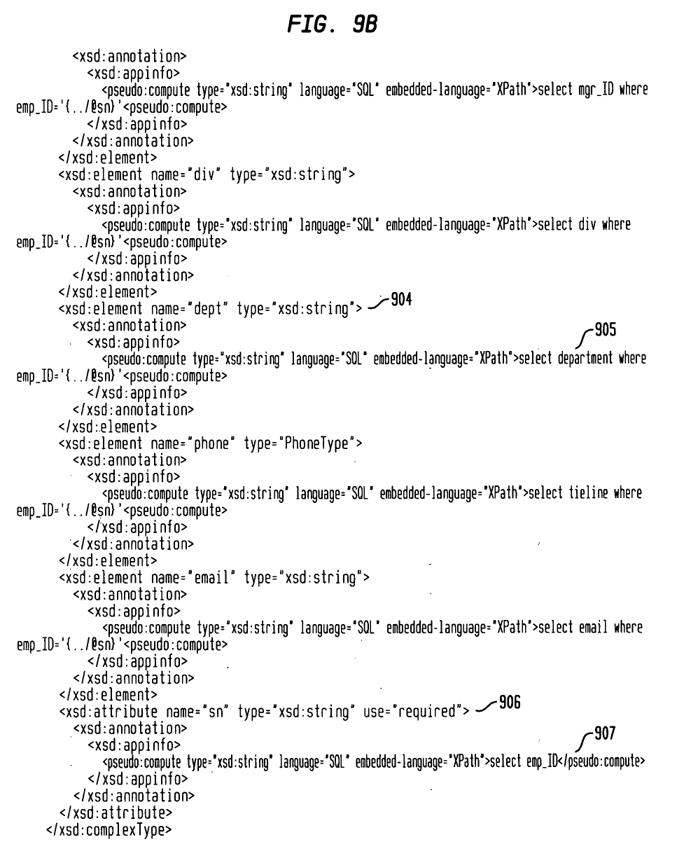

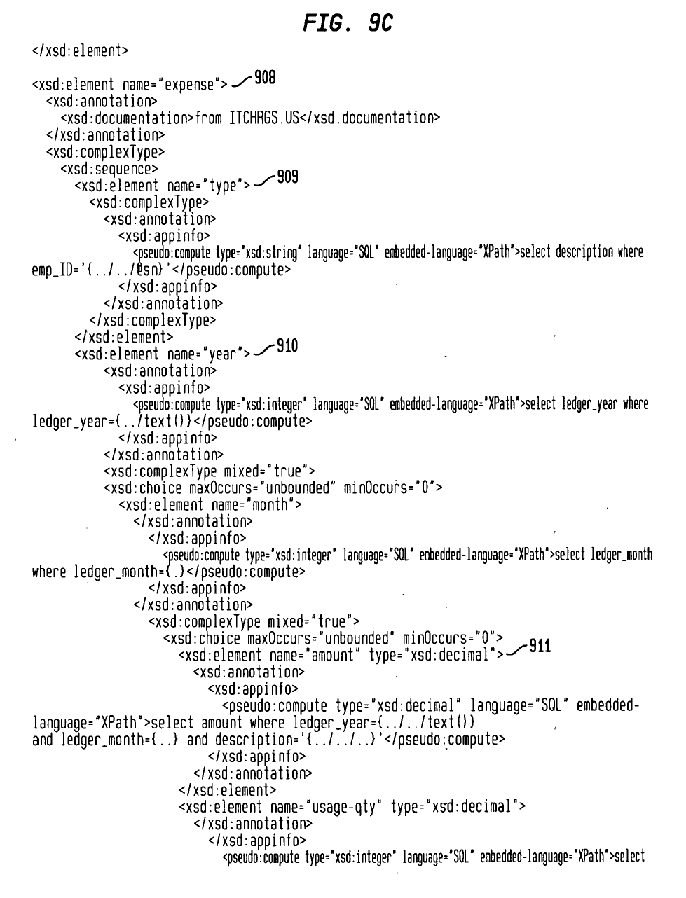

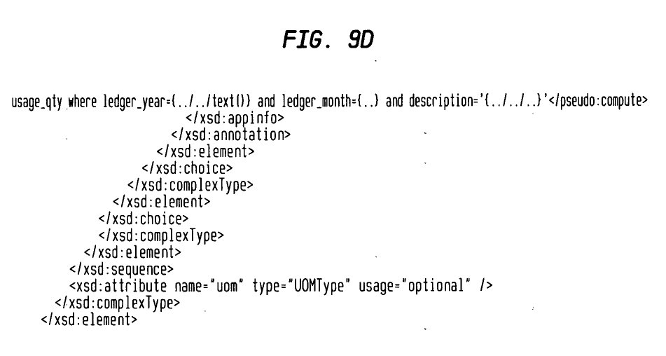

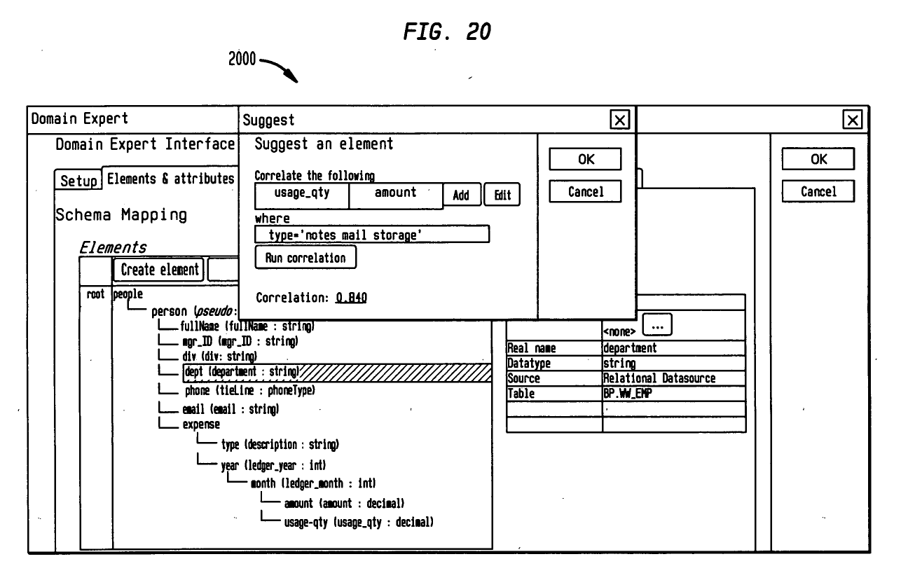

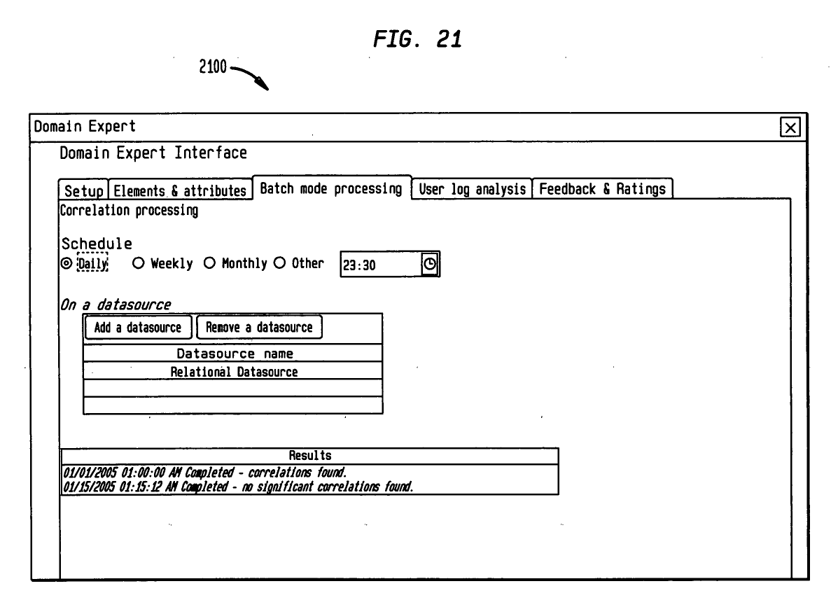

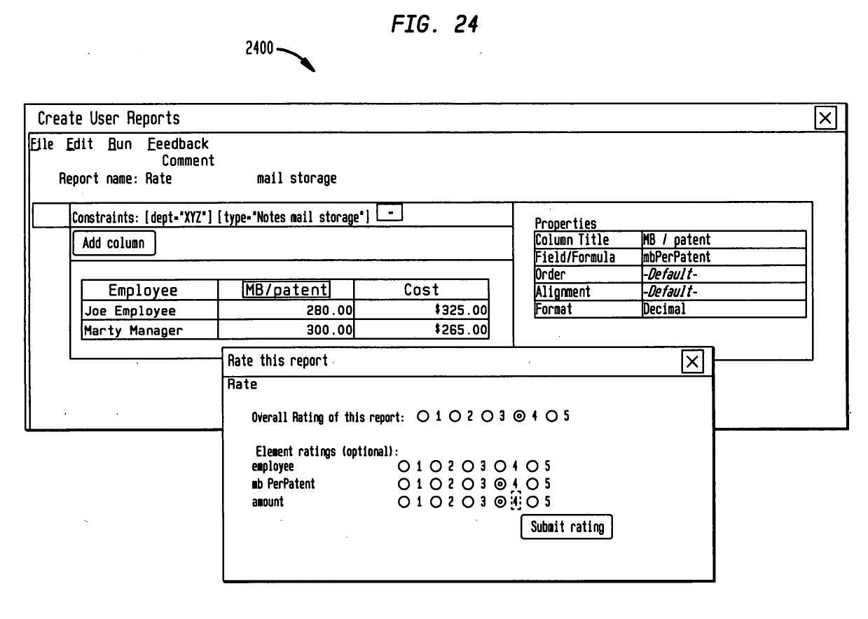

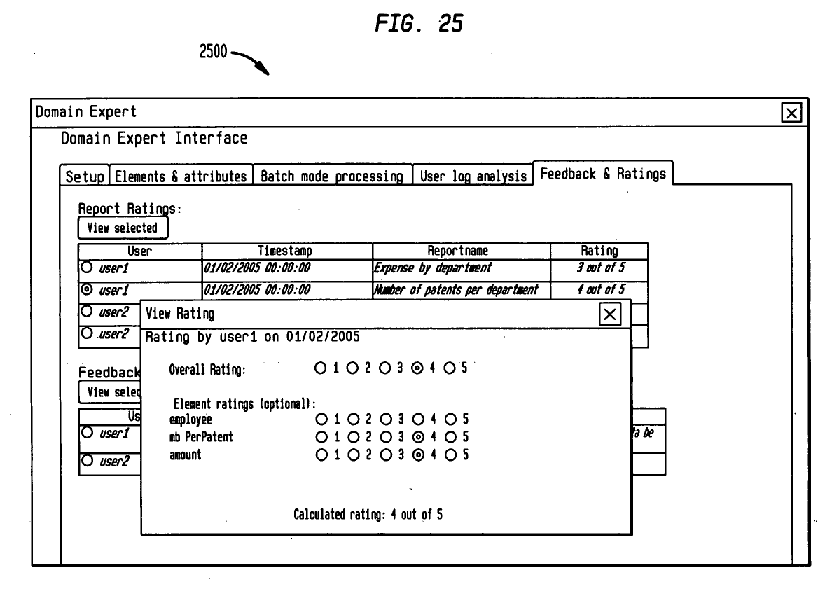

The build-time system 170 defines the structured data and the access method to the data. It encompasses the Domain Expert user interface (UI) 112, which, through the API 165, is used to define those data sources, e.g., as illustrated in the Domain Expert UI 500 of FIG. 5, and, in conjunction with the virtual schema builder 160, constructs the initial virtual schema and subsequent iterations thereof. See, e.g., the Domain Expert UIs 700 and 800 of FIGS. 7 and 8, respectively, and the example initial virtual schema of FIGS. 9a-d. The build-time system includes both a batch, or off-line correlation process, as illustrated by the Domain Expert UI 2100 of FIG. 21, which can suggest, to the Domain Expert, potentially relevant relationships between data elements and a real-time suggestion function for one-to-one correlations between selected elements available in the Domain Expert interface, as illustrated by the Domain Expert UI 2000 of FIG. 20. The identification of the potentially relevant relationships can assist the Domain Expert in creating additional pseudo-elements. The build-time system, after successive iterations of user report logging and feedback (See, e.g., the example End User UI 2400 of FIG. 24 and the example Domain Expert UI 2500 of FIG. 25) allows the Domain Expert to refine and build upon the virtual schema. The build-time system enables the Sponsor and Service Provider to monitor performance metrics such as average user satisfaction, average End-User cycle type for report generation, or average End-User satisfaction with individual provided data elements. The build-time system optionally enables the Service Provider, via the example Service Provider UI 400 shown in FIG. 4, to modify various optional service provision parameters including, but not limited to, graphical and visual representation of data, the type of correlation tool employed, and the frequency of data updates so as to enable the Service Provider to meet their contractual obligations for the performance metrics associated with the service level agreement with the Sponsor.

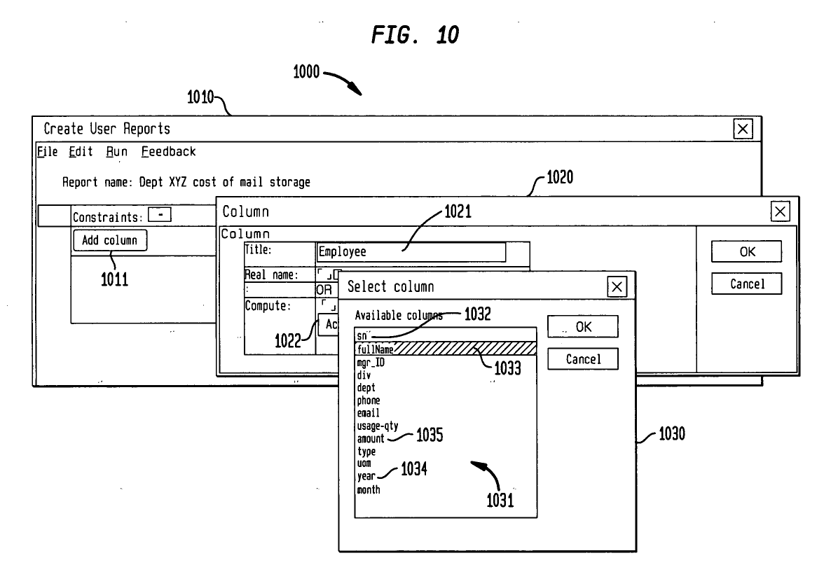

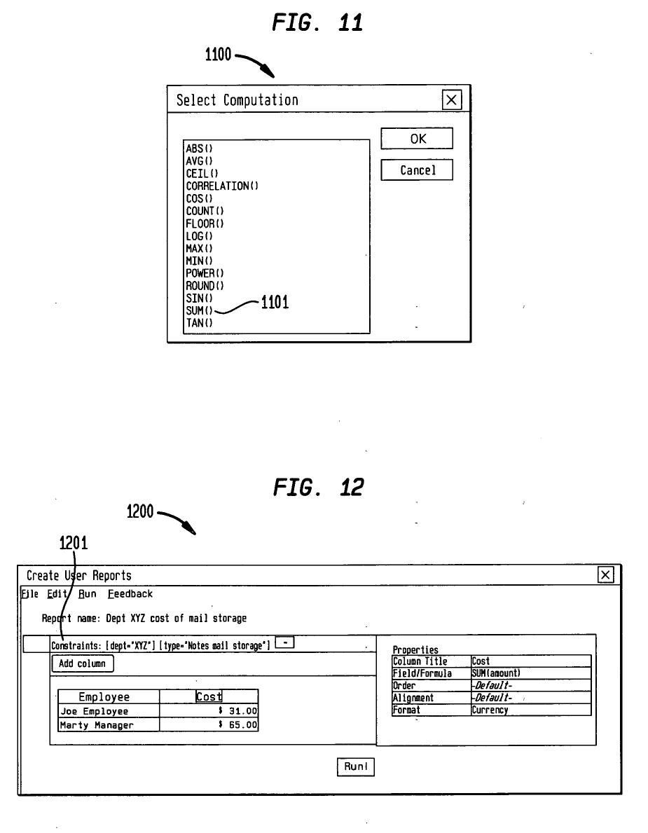

The run-time system is directed to providing the end user with the ability to create an exception report from the previously built virtual schema (FIGS. 9a-d). The end user is able to select elements from the virtual schema, both real and pseudo, apply constraints or computations (as shown in the End User UI 1200 of FIG. 12) to these elements all through the End User UI 1000 illustrated in FIG. 10. The end user is able to run these reports until the desired results (shown in the End User UI 1200 of FIG. 12) are obtained in the report, at which time they can save the reports for future use. The run-time system additionally provides end users with an opportunity to rate the provided exception query report results, e.g., as illustrated in End User UI 2400 of FIG. 24. All of the available functionality for the run-time system is done through the API that interfaces with each of the stakeholder user interfaces 112, 122, 132 and 142 (FIG. 2). In addition, the API is also made available to the set of Web Services 210 that allows remote interaction with the system, e.g., as depicted in FIG. 2. Here, through the Web Services 210, data sources can be selected, constraints given, reports generated, and metrics can be analyzed.

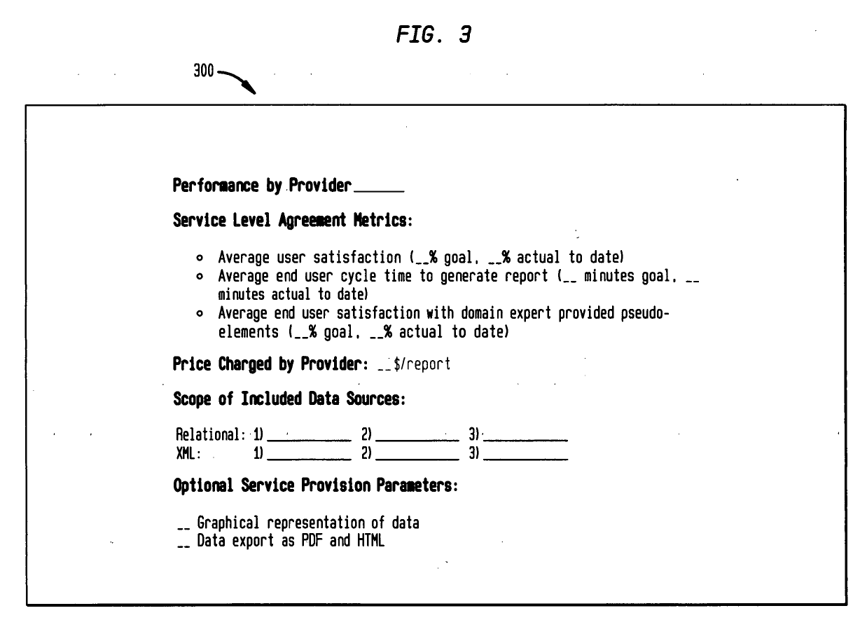

The operation of the inventive system is initiated when the Sponsor and Service Provider agree on the performance metrics associated with the delivery of exception reporting services to end users and programmatic interfaces, and enter or modify the specifics of the service level agreement (SLA) on a Sponsor's UI 300 (FIG. 3). As shown in FIG. 3, the Sponsor U 300 enables the Sponsor to enter or modify the performance metrics including, for example, average user satisfaction, average End-User cycle time to generate a report, or average End-User satisfaction with provided data elements. The Sponsor, via the Sponsor's UI 300, can additionally elect to include a graphical representation of exception reporting data and data export options in the exception reporting service interface provided to end users.

Pre-Processing Steps Before First User Query

After agreement on the performance metrics for the exception reporting service level agreement between the Sponsor and Service Provider, and before the first query, the system can perform several pre-processing steps, including the building of an initial virtual schema from the scope of the included data specified on the Sponsor UI 300, e.g., as illustrated in FIG. 3. In one possible approach, the steps involved with the initial building of the virtual schema as well as the later updating are under the control of the Domain Expert through its UI 700 as shown in FIG. 7.

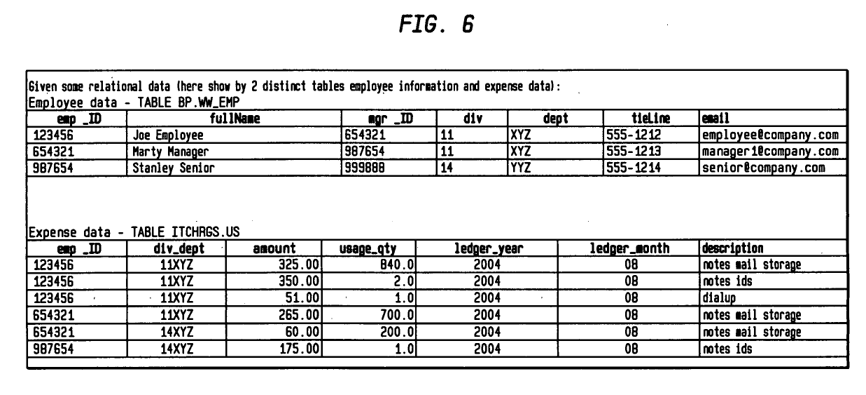

Given a set of available, structured data in the system, the Domain Expert, through the UI 500 illustrated in FIG. 5, establishes those data, which have been previously agreed upon by the Sponsor and Service Provider, that are to be included and made available to the system and the access methods to retrieve the data from those sources. Illustrated in FIG. 6 are sample relational tables of data elements, or concrete schema, from a relational database along with some sample data. This relational data schema is used by the Domain Expert to create an initial virtual schema through the UI 700 illustrated in FIG. 7. The Domain Expert can define an element in the virtual schema by selecting the source from which it is described (not applicable if the element is computed), naming it, and assigning a data type. The Domain Expert UI 800 of FIG. 8 shows the original set of relational tables (FIG. 6) as a virtual schema representing both “pseudo elements”, e.g., those that do not exist in the actual data, such as the person element, and real elements, e.g., the dept. element, which is the department column derived from the BP.WW_EMP table of the Relational Datasource. FIGS. 9a-d illustrate the initial virtual schema as built by the Domain Expert through the UI 500 illustrated in FIG. 5. The virtual schema is then made available to the End Users through their interface 1000 (FIG. 10).

First End User Query

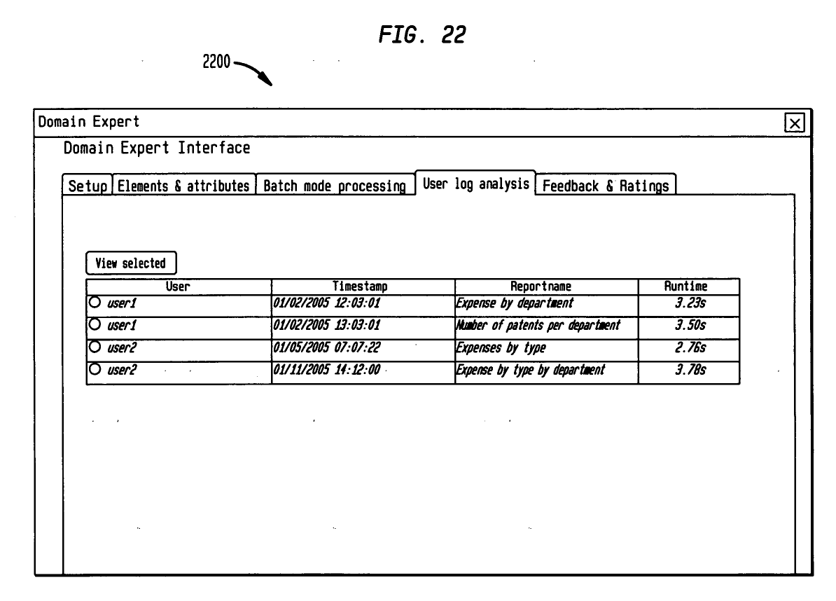

End Users interact with the system via the End User UI 1000 illustrated and described herein with respect to FIG. 10. The End User can instantiate an exception report through the interface 1000 by selecting any of the elements made available through the virtual schema shown in FIGS. 9a-d. Upon selecting an element as a particular column in the report, constraints can be applied to filter the report to a meaningful subset of data. Optionally, as illustrated in the example list of library functions 1100 of FIG. 11, computations can be applied to one or more of the selected rows. When the end user is satisfied that the report is showing the filtered subset of the data that is desired, the report can be run and viewed through the End User UI 1200 as illustrated in FIG. 12. Successions of additional report columns and constraints can be added until a satisfactory report is created. At this time, the report can be saved for future use by the End User or other End Users. Furthermore, in accordance with the service level agreement (SLA) between the Sponsor and the Service Provider, metrics (FIG. 3), such as average end user satisfaction, average cycle time for report generation, and average level of satisfaction of individual elements, can be gathered from the End User through the feedback-rating mechanism in the End User UI 2400 shown in FIG. 24 and from the Logging Service 185 noted in FIG. 1. In the UI 2400, the End User can rate overall reports as well as each individual data element provide by the system through the virtual schema made available by the Domain Expert. The accumulation of logging, user feedback and user ratings are gathered and made available to the Domain Expert via the Domain Expert UIs 2200, 2300 and 2500 of FIGS. 22, 23 and 25, respectively, at which time the system can be enhanced or enriched, e.g., by making new data sources available, adding/updating/removing elements (“pseudo” or real), indexing the data, or rearranging the virtual schema into a different hierarchy.

The following discussion illustrates an example use of the invention in generating and storing exception reports. A first part of the discussion relates to introducing XML Query (XQuery) as a representation for virtual queries, while a second part of the discussion relates to running such queries.

Part I: Introduce XQuery as a Representation for Virtual Queries.

One way of using the inventive system to generate exception reports through web services, as well as of storing report generations created using the user interface, is to assemble the entire report generation in a single “query”, expressed, for example, in the XML Query programming language. See the W3C Working Draft, dated 04 Apr. 2005, and entitled “XQuery 1.0: An XML Query Language” at http://www.w3.org/TR/xquery. For example, the Employee/Cost table (FIG. 12) could be generated (in HTML) by the following XQuery expression:

<table><tr><th>Employee</th><th>Cost</th></tr>{

for $employee in /people/person[dept=“XYZ”]
return

<tr><td>{ $employee/fullName }</td><td>{

sum($employee/expense[type=“Notes mail storage”]/
year/month/amount)

}</td></tr>

}</table>

The XQuery expression makes it explicit exactly as to which node each property should be applied, both in terms of the organizing structure (for example, the “type” constraint applies to “expense” elements) and the actual instance, whereas these relationships were hidden in the End User UI (FIGS. 10 and 12).

The following details how a query is generated from the UI. One could imagine the above query being generated from the End User UI. The context is that the user has selected to do “person exception reporting” so we assume that the XML Schema (FIG. 9) is available to the application that is showing the “Create User Reports” window (1010). The user then clicks on the “Add column” button (1011) and enters into the “Column” dialog (1020) the title of the column, “Employee” (1021), and clicks on an “Add Computation” button (1022), which is partially obscured in FIG. 10. Because the application knows that the current nodes will be “person” nodes, it suggests in the “Select column” dialog 1030 all the properties that are declared in the XML Schema (FIG. 9) as subelements of “person” (1031 and 901): “sn”, which denotes a serial number (1032 and 906), “fullName” (1033 and 903), etc., as well as all nested properties such as “year” (1034 and 910), that is actually a family of properties indexed by expense, and “amount” (1035 and 911) which is indexed by expense, year, and month. When the user selects “fullName” (1033) we can capture the single “Employee” column by the following XQuery:

<table><tr><th>Employee</th><th>Cost</th></tr>{

for $employee in /people/person
return

<tr><td>{ $employee/fullName }</td></tr>

}</table>

A similar interaction is used to create a second column, “Cost”, for which the “amount” property is chosen. Since the “amount” property corresponds to an element that is particular to a month in a year of an expense (908), the user has to select the aggregation principle to use for each of those indexes. The aggregation is done by a function as shown in FIG. 11 where the user then selects the “SUM” function (1101) to aggregate all the amounts. The result is the following query:

<table><tr><th>Employee</th><th>Cost</th></tr>{

for $employee in /people/person
return

<tr><td>{ $employee/fullName }</td><td>{

sum($employee/expense/year/month/amount]

}</td></tr>

}</table>

Finally, the user adds two constraints in a similar fashion, resulting in the end user reporting interface 1200 of FIG. 12, which shows the finished generation with constraints on the two properties “type” and “dept” (1201). By looking at the XML Schema (FIGS. 9a-d), we see that “type” (909) is a subelement of “expense” (908), and “dept” (904) a subelement of “person” (901), which implies that the constraints should be inserted as follows in the XQuery:

<table><tr><th>Employee</th><th>Cost</th></tr>{

for $employee in /people/person[dept=“XYZ”]
return

<tr><td>{ $employee/fullName }</td><td>{

sum($employee/expense[type=“Notes mail storage”]/
year/month/amount)

}</td></tr>

}</table>

Note that the XQuery generation depended only on the XML Schema declarations, not on the pseudo-element annotations.

Part II: Running the Query

At runtime, the query is applied to an actual data instance that obeys the organizational structure. In the present example, this means the complete data instance is an XML document which is “valid” for the XML Schema in FIG. 9. Here, we show how the query is evaluated over our example data, especially how only the required parts of the data are queried and materialized.

Before the query is evaluated, the document can be illustrated as follows

<people>

. . .

</people>

where “ . . . ” here and below denotes unmaterialized content; in this case, the content of the “people” element has not yet been materialized. The first operation of the query is to enumerate all the “person” child elements. The XML Schema (FIGS. 9a-d) informs us that the content of “people” consists of a sequence of one “person” element per “sn” attribute (906), that “person” elements correspond to records of the table retrieved using the SQL fragment “from BP.WW_EMP” (902), and, for each part of the content, how it is extracted from that table, In particular, the “sn” attribute is obtained by “select emp_ID” from the table (907). This combines to us evaluating the SQL query “select emp_ID from BP.WW_EMP” and, assuming that returns just “123” and “456”, updates the document to the following:

<people>

<person sn=“123”>. . .</person>
<person sn=“456”>. . .</person>

</people>

Next the query requires us to test the “dept” child of each “person” to filter out just those with the value “XYZ”. This is achieved by computing the SQL expression associated with the “dept” element (904) which for each new “dept” element evaluates the SQL statement “select department from BP.WW_EMP where emp_ID=‘{ . . . /@sn}’” (905), so the document becomes:

<people>

<person sn=“123”>. . .<dept>ABC. . .</dept>. . .</person>
<person sn=“456”>. . .<dept>XYZ. . .</dept>. . .</person>

</people>

Because of the constraint, the for loop will only bind $employee to the second “person” element. The loop body then needs to compute the “fullName” child by the SQL query “select fullName from BP.WW_EMP where emp_ID=‘{ . . . /@sn}’” which extends the document to the following:

<people>

<person sn=“123”>. . .<dept>ABC. . .</dept>. . .</person>
<person sn=“456”>. . .<fullName>Joe

Employee</fullName>. . .<dept>XYZ. . .</dept>. . .</person>

</people>

For the remainder of the XQuery expression, “sum($employee/expense[type=“Notes mail storage”]/year/month/amount)”, the same logic is repeated by first enumerating all the “expense” element children of “person” by calculating their “type” children with the SQL “select description from ITCHRGS.US where emp_ID=‘{ . . . / . . . /@sn}’” and then, for each “expense”, where the “type” string value satisfies the constraint, evaluate the list of “amount” elements under it. Note that, for nested values such as “amount”, the constraints of the parents are inherited so the amounts under a particular “year” and “month” combination are computed by a SQL statement such as the following:
select amount from ITCHRGS.US where ledger_month={ . . . /tex( )} and ledger_year={ . . . / . . . /tex( )} and type={ . . . / . . . / . . . /type}
   where the “select” declarations of the context reappear as constraints to ensure that all descendants of each actual element really are related to that element specifically.
   Creation and Use of Pseudo-Element

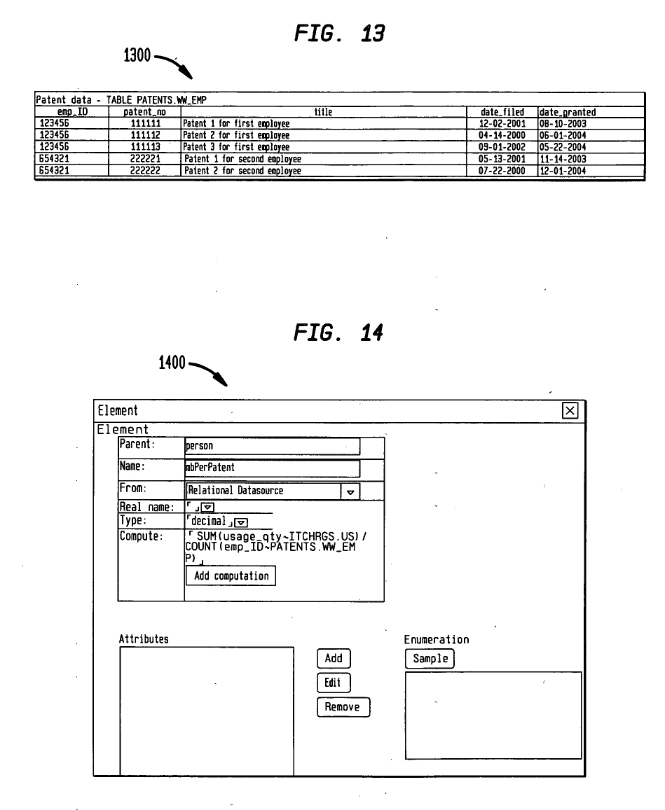

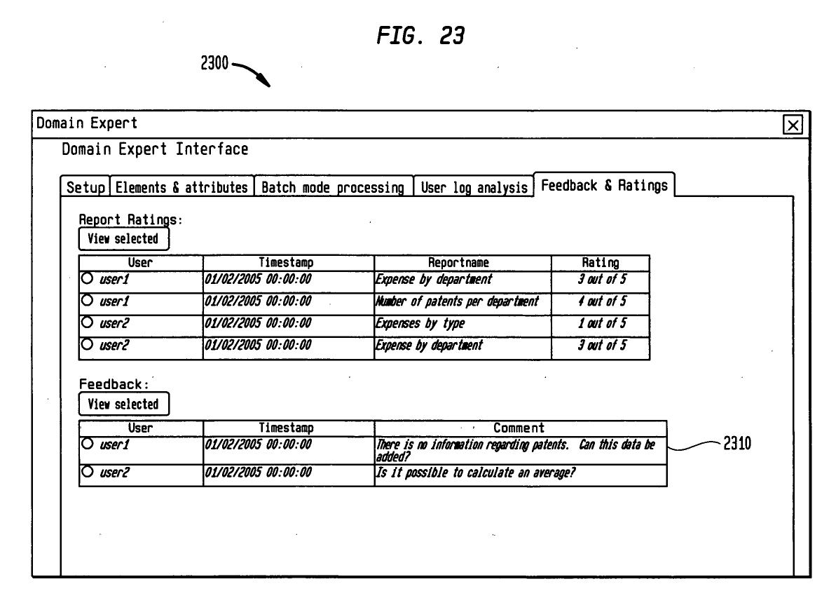

The inventive system provides the capability to include unmaterialized, computed data fragments in the aforementioned virtual schema navigated by the end user in the process of creating their exception reports. These “pseudo-elements” are created by the Domain Expert based on a variety of inputs. In one possible scenario, the end user, through their interface 100 (FIG. 10) views the available set of elements in an attempt to create a report. For example, assume the end user wishes to create a report with data relating to patents since the end user suspects that the number of patents held by an employee is related to the mail storage used by the employee. In this case, the end user submits feedback to request (of the Domain Expert) the inclusion of such data. Feedback provided by an end user is made visible to the Domain Expert via the Domain Expert's UI 2300 (FIG. 23). For example, see the display area 2310, which states: “There is no information regarding patents. Can this data be added?” This feedback motivates the Domain Expert to add a new relational data source and its corresponding table 1300 (FIG. 13). This suggests an element feature is an interactive correlation process available to the Domain Expert via his or her interface, as shown in FIG. 20.

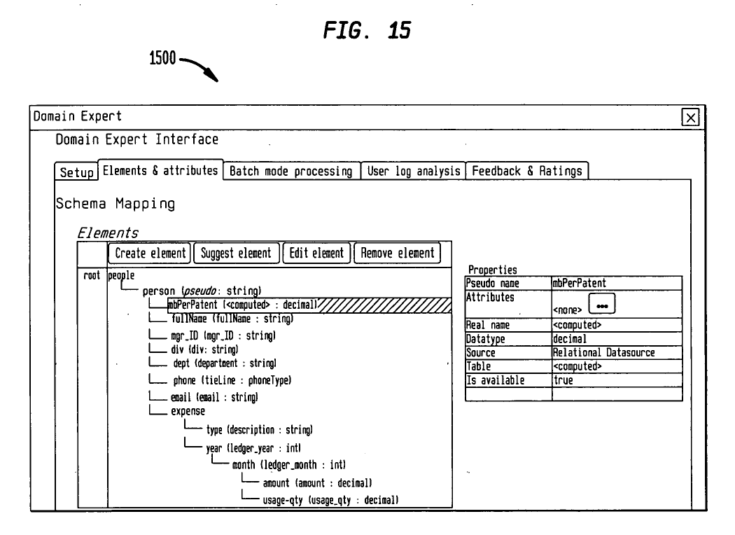

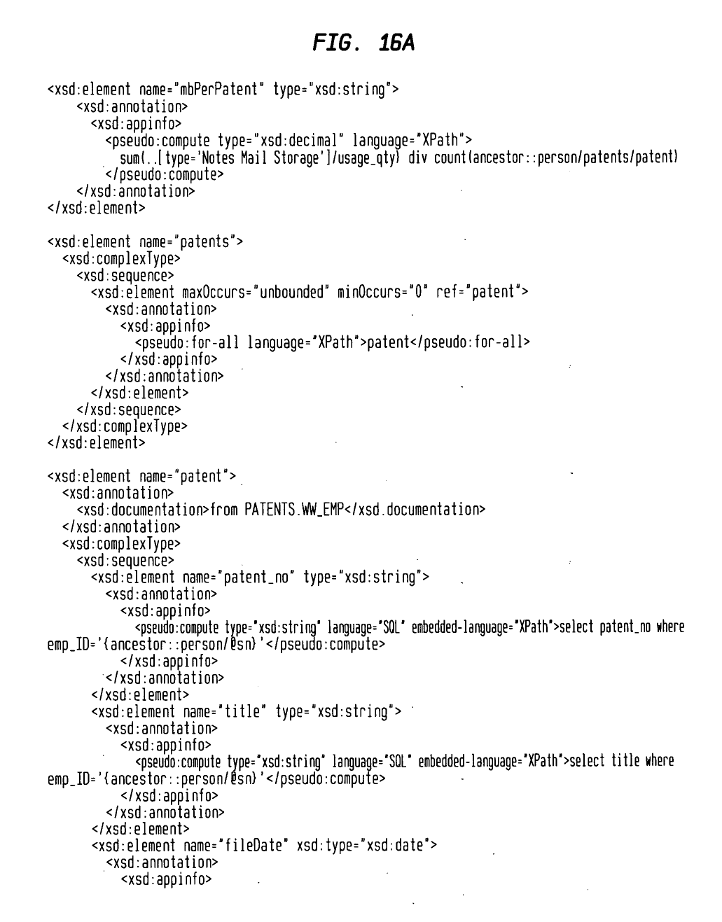

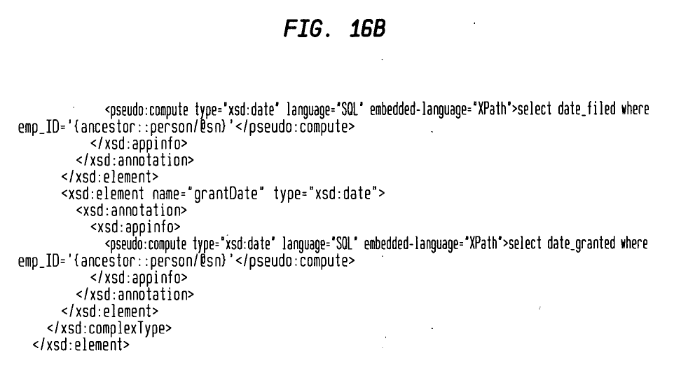

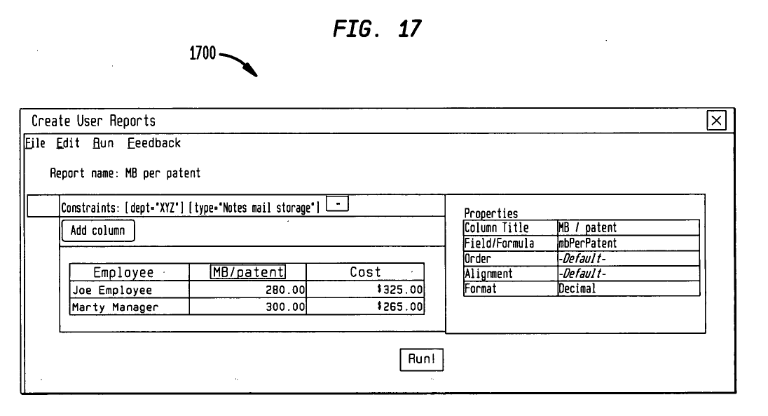

Alternatively, the Domain Expert can run batch correlation processes, noted by the correlation process 155 in FIG. 1 via the Domain Expert UI 2100 of FIG. 21. Using either method to identify a meaningful correlation, a “pseudo-element”, mbPerPatent, can be created by the Domain Expert to represent this relationship between number of patents and mail storage consumed. FIG. 14 illustrates a Domain Expert UI 1400 for creating a pseudo-element based on a relationship between these two data elements. FIG. 15 illustrates the completed pseudo-element in the Domain Expert's UI 1500. The updated virtual schema portion representing this pseudo-element is shown in FIGS. 16a and 16b. Annotations to the schema describe how to materialize this new “pseudo-element”. This enriched dataset is now made available for subsequent user queries. FIG. 17 illustrates the End User's reporting UI 1700 for adding the newly completed pseudo-element.

Parametized Element

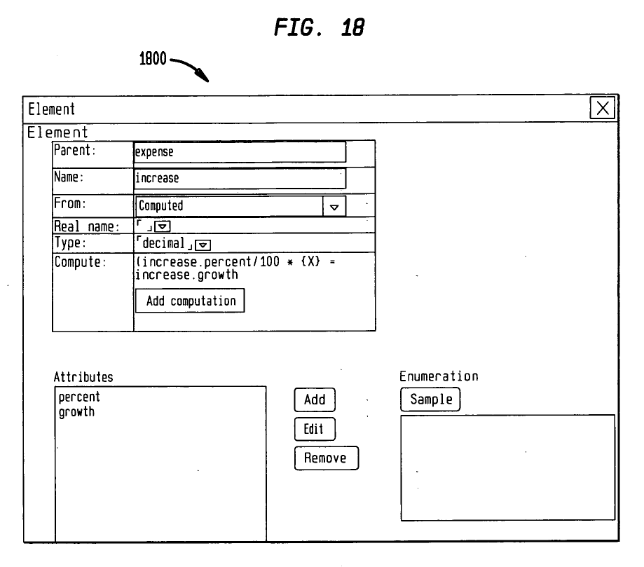

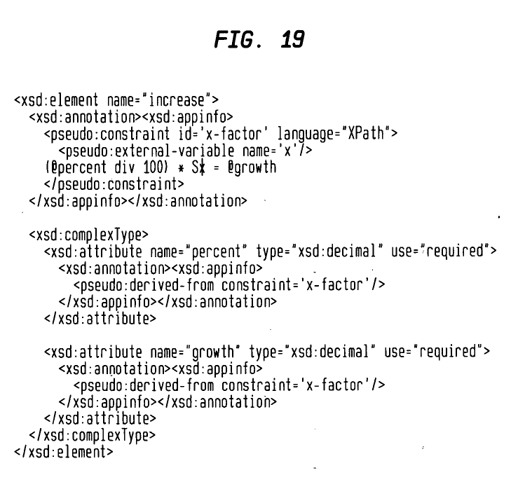

The virtual schema can represent true elements, e.g., those derived directly from the data, or “pseudo-elements”, e.g., those materialized when requested according to their context in the schema. A special type of “pseudo-element” which can be created and used by the inventive system is a parametized element, or one that requires input from the user. Illustrated in FIG. 18 an example domain expert interface 1800 showing the creation of a parametized pseudo-element. This element's attributes can be user input parameters to a formula on an external data element. FIG. 19 illustrates the virtual schema as it contains a parametized pseudo-element for calculating the growth rate or percent increase of an external element. Both the input parameters and the computed formula are described in the annotations to the virtual schema.

Programmatic Interface

The application programming interface (API) 165 interacts with each of the subsystems as depicted in FIG. 1. The API, in turn, is used by the respective users' interfaces 112, 122, 132 and 142, to manipulate each of the subsystems. For example, the Domain Expert 110, through the Domain Expert interface 112, can use methods in the API to create new data sources, update and create elements (or attributes) in the virtual schema, analyze user reports, feedback and logs. In addition to the interaction of users, through the respective interfaces, with the API, the API is made available (as shown in FIG. 2) to Web Services 210. Through Web Services, service requests and responses to the API are possible.

System Adjustments

Over time, the inventive system begins to “learn” the queries that other users have written that may be meaningful. To be meaningful, subsets of the data exist where some exception condition applies. Saved queries are made available to all subsequent users, as well as to subsequent queries by the same user. In addition, the Domain Expert can use a log of the queries to pinpoint performance enhancements, pseudo elements, or even new data sources or views to the data, as discussed in the previous scenarios.

In addition, the inventive system enables the Service Provider to invoke, on demand, additional services in response to performance metrics deficiencies or changing business requirements for exception reporting services. For example, if the metric for the average end user satisfaction with domain expert provided pseudo-elements, as noted on the Sponsor's User Interface 300 of FIG. 3, is below that agreed upon in the service level agreement, the Service Provider, via their User Interface 400 of FIG. 4, can elect, at their own expense, to provide a more expensive, customized correlation tool used in either batch or interactive mode by the Domain Expert in their interfaces 2100 and 2000 illustrated respectively in FIGS. 21 and 20 to identify new data sources to use in the creation of these pseudo-elements.

In another system adjustment scenario, the metric for average user satisfaction might be improved by increasing the frequency of data source updates, in order to provide more up to date reports to end users who might have used outdated data to erroneously notify employees in their organizations of unacceptable exception conditions. In this situation the Service Provider can increase the data source update frequency via their User Interface 400 in FIG. 4 and monitor changes in the relevant metric.

Those skilled in the art will recognize that the system's service oriented architecture can be implemented using a number of different technologies. While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A computer-implemented method for enriching data sources, comprising:
creating a tree based organizing structure for heterogeneous structured enterprise data sources having associated structured data;
including unmaterialized, computed data fragments on demand in individual data elements in the organizing structure; and
navigating to nodes in the organizing structure so as to provide localized, context sensitive enrichment of the data sources.

2. The computer-implemented method of claim 1, wherein the data sources comprise relational data sources.

3. The computer-implemented method of claim 1, wherein the data sources comprise hierarchical data sources.

4. The computer-implemented method of claim 1, wherein the localized, context sensitive enrichment is based on notation for the data sources which allows navigating to the individual data elements, which are described through paths, and expressing possible navigation steps relative to the paths and the data associated with the data elements visited along the paths.

5. The computer-implemented method of claim 1, wherein the creating, including and navigating are performed using programmatic interface calls.

6. The computer-implemented method of claim 5, wherein the programmatic interface calls are initiated by a web service.

7. The computer-implemented method of claim 1, further comprising:
receiving, from a sponsor entity, specification of performance criteria associated with providing an exception reporting service at a requested performance level for end-users.

8. The computer-implemented method of claim 7, further comprising:
receiving, from a service provider entity, specification of service provision parameters for providing the exception reporting service according to the requested performance level.

9. The computer-implemented method of claim 1, further comprising:
enabling end-users to perform services including navigation, selection and query building functions, and viewing results from executed report queries; and
enabling the end-users to provide feedback on the services.

10. The computer-implemented method of claim 9, further comprising:
monitoring, logging and storing the built queries, report results and feedback provided by the end-users.

11. The computer-implemented method of claim 9, wherein the feedback includes at least one of ratings and comments pertaining to the requested performance level.

12. The computer-implemented method of claim 9, wherein the feedback pertains to pseudo-elements used to enhance the virtual schemas.

13. A computer-implemented method for enriching data sources, comprising:
creating a tree based organizing structure comprising a virtual schema for heterogeneous structured enterprise data sources having associated structured data;
including unmaterialized, computed data fragments on demand in individual data elements in the organizing structure; and
navigating to nodes in the organizing structure so as to provide localized, context sensitive enrichment of the data sources.

14. The computer-implemented method of claim 13, further comprising:
enabling a domain expert to perform selection, building and enhancing functions for the virtual schema.

15. The computer-implemented method of claim 13, wherein the virtual schema includes a per-element mixture of concrete elements and computed pseudo-elements that are generated dynamically from the data sources.

16. The computer-implemented method of claim 13, further comprising:
enabling a domain expert to select the structured data for the virtual schema.

17. The computer-implemented method of claim 13, further comprising:
enabling a domain expert to build the virtual schema.

18. The computer-implemented method of claim 13, wherein the use of the virtual schema instead of complete virtual instances reduces the computer resources required to provide an exception reporting service according to a requested performance level.

19. The computer-implemented method of claim 18, wherein the reduced required computer resources result from context sensitive computations when navigating the organizing structure.

20. The computer-implemented method of claim 13, further comprising:
enabling end-users to navigate the virtual schema, select the structured data and specify constraints to build exception report queries.

21. The computer-implemented method of claim 20, wherein the data elements include open-ended parameters so as to enable the end-users to include hypothetical scenarios in the exception report queries.

22. The computer-implemented method of claim 20, further comprising:
executing the exception report queries.

23. The computer-implemented method of claim 20, further comprising:
enabling the end-users to use library functions to include at least one of totals, averages and other statistics based on selected data in the exception report queries.

24. The computer-implemented method of claim 20, wherein
the inclusion of virtual data materialized on-demand from the data sources in the structured heterogeneous data is transparent to the end-users.

25. The computer-implemented method of claim 13, further comprising:
enabling a domain expert to computationally enhance the structured data and the virtual schema with pseudo-elements.

26. The computer-implemented method of claim 25, further comprising:
enabling end-users to perform navigation, selection and query building functions, view results from executed report queries, and provide feedback on a requested performance level; and
enabling the domain expert to analyze the queries, results and feedback to modify the virtual schema and the pseudo-elements to optimize performance criteria agreed upon by a sponsor and a service provider.

27. The computer-implemented method of claim 25, further comprising:
suggesting the pseudo-elements to the domain expert based on the end-user feedback and optional real time or batch correlation processes for identifying potentially relevant relationships between elements of the data.

28. The computer-implemented method of claim 25, further comprising:
enabling a domain expert to use library functions to include at least one of totals, averages and other statistics in formulas used to create the pseudo-elements.

29. The computer-implemented method of claim 25, wherein the pseudo-elements enable the end-users to explore at least one of boundary conditions and exception conditions in the data.

30. A program storage device tangibly embodying software instructions which are adapted to be executed by a processor to perform a method for enriching data sources, the method comprising:
creating a tree based organizing structure for heterogeneous structured enterprise data sources having associated structured data;
including unmaterialized, computed data fragments on demand in individual data elements in the organizing structure; and
navigating to nodes in the organizing structure so as to provide localized, context sensitive enrichment of the data sources.
